(19) United States
(12) Patent Application Publication
(10) Pub. No.: US 2010/0147155 A1
(43) Pub. Date: Jun. 17, 2010

(54) MACHINES FOR THE PRODUCTION OF ESPRESSO-LIKE INFUSIONS

(76) Inventor: Gino Rapparini, Bologna (IT)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/597,592

(22) PCT Filed: Apr. 3, 2008
(86) PCT No.: PCT/IB08/00806

§ 371 Date: Oct. 26, 2009

(30) Foreign Application Priority Data
Apr. 24, 2007 (IT) BO2007A000302

(51) Int. Cl. A47J 31/44; A47J 31/46

(52) U.S. Cl. 99/281; 99/300; 99/285

(57) ABSTRACT

Improvements to machines for the production of espresso-like infusions characterized by the fact that they are based on a combination of devices (B, P, R, S, T) that detect, control, regulate and modulate the instant value variations of the technological, thermometric, hydrodynamic and cinematic and chronology parameters that optimize the preset quality of the resulting customized espresso.

### FIELD OF THE ART

The present invention refers to the technological field of the construction of machines to obtain infusions such as espressos. International classification of reference A47 j.

### STATE OF THE ART

Several types of machines to obtain infusions such as espresso are known. No known machines features the global combination of devices that supervise the control an the programmed and modulated regulation of the instant values of the different technological, thermometric, hydrodynamic and chronologic parameters of all the infusions process to obtain espressos of customized excellent and present quality.

The problem to be solved is exactly to realize an optimal espresso machines, easy to operate, affordable in the construction and reliable in its functioning, particularly at home.

### DESCRIPTION

The invention is now disclosed with reference to the figures of the drawing, which are attached as unrestrictive examples.

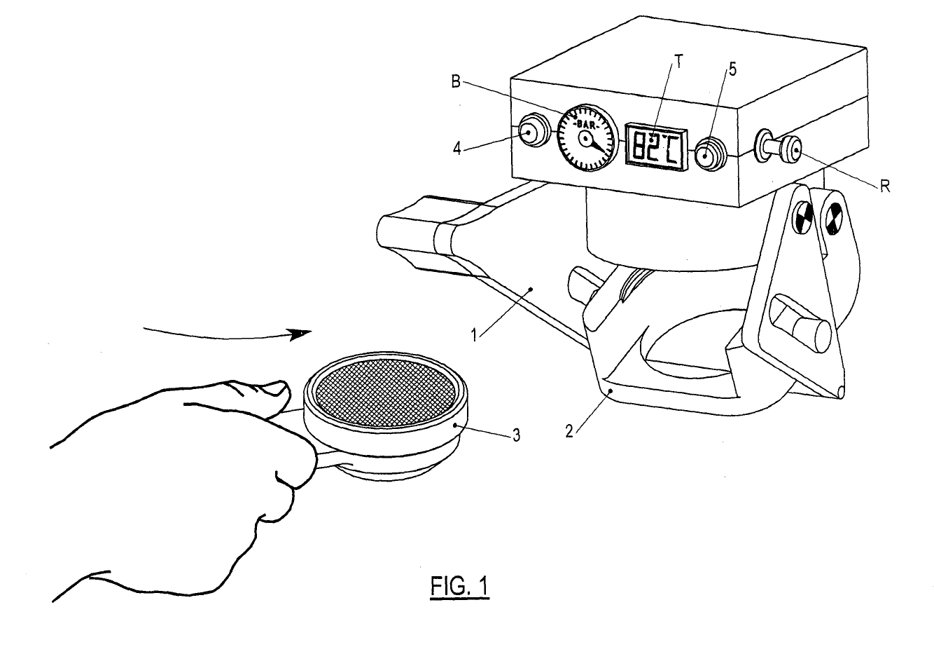

FIG. 1 represents an axonometric general view of an espresso machines equipped with all the device s for the programmed conduction of all the modulated infusions processes to obtain high quality customized infusions.

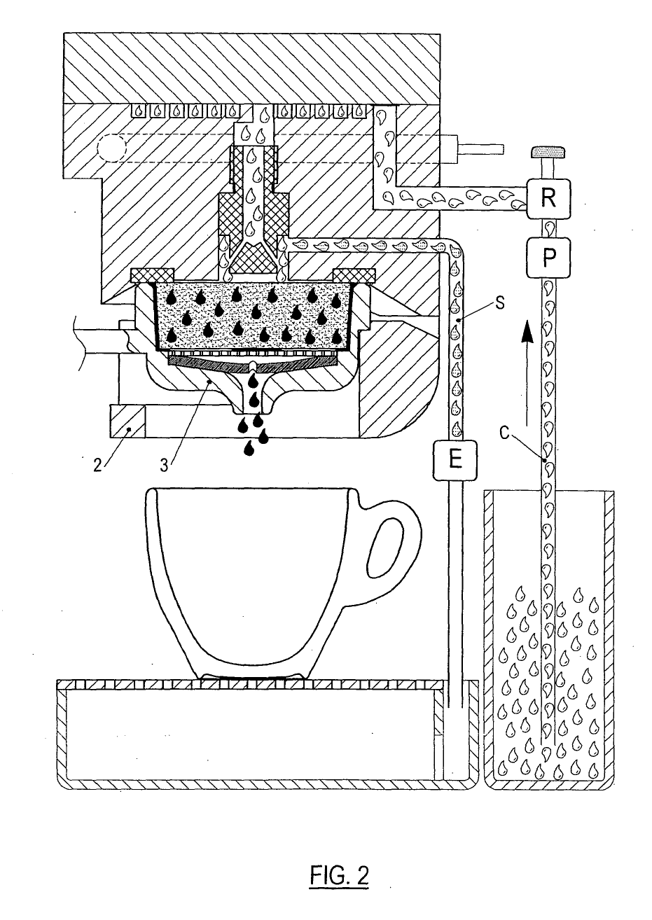

FIG. 2 shows in section the functioning of the infusion process.

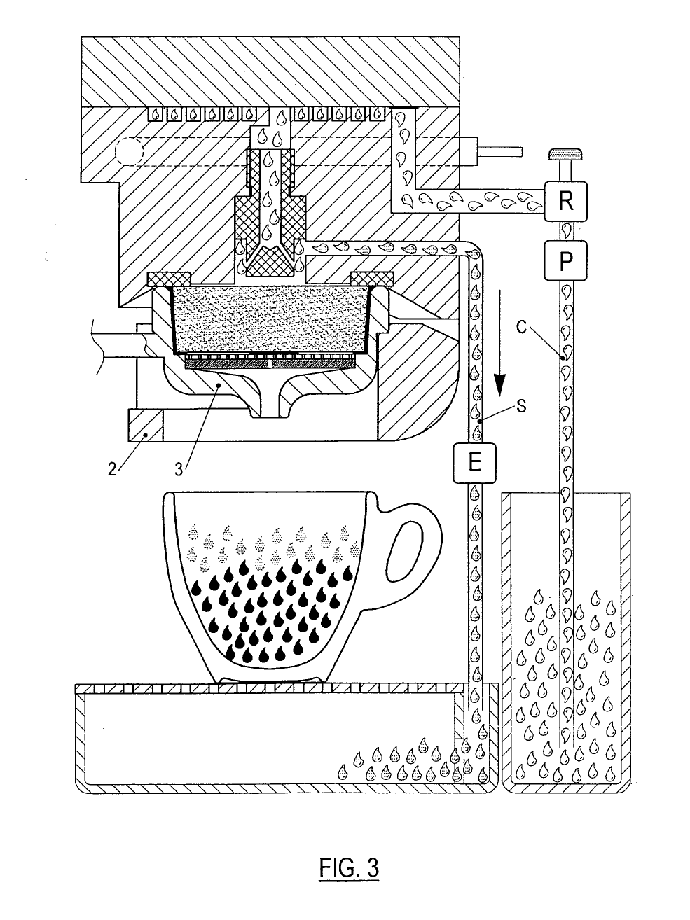

FIG. 3 shows the discharge phase of the residual pressure of the fluid at the end of the infusion process.

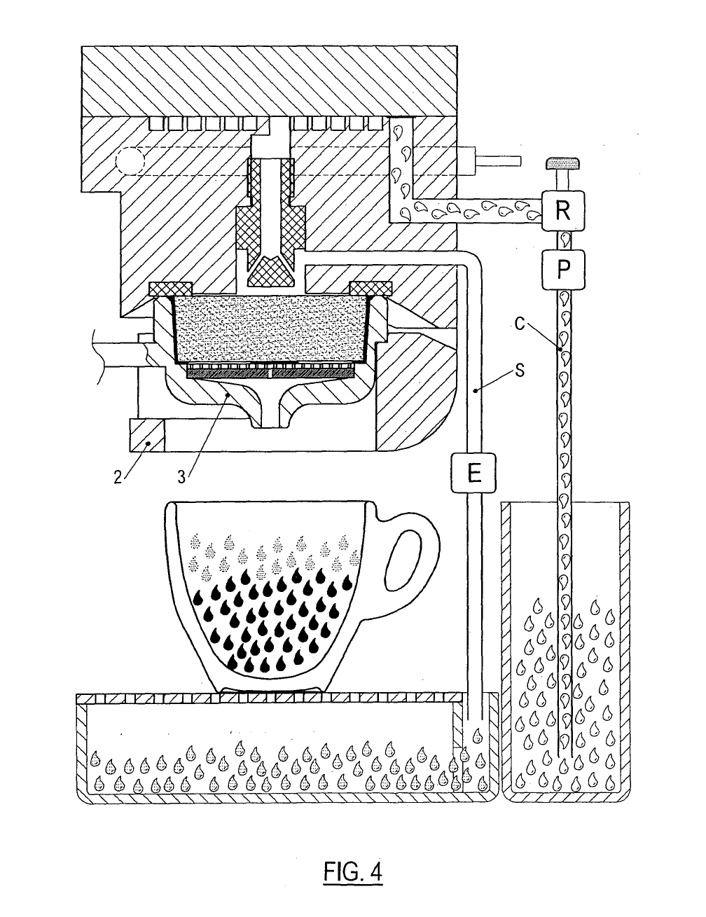

FIG. 4 shows the machine already clean ad ready to start a new cycle.

In all figures each single detail is marked as follows:

B indicates a device that control the pressure of the process fluid.
C indicates a intake conduit of the process liquid.
E is a discharge electro-valve.
P indicates a pump which load the process fluid.
R indicates a device regulating the load of the pump (P) that feeds the process fluid.
S indicates a relief conduit of the residual pressure o the fluid at the end of the infusion process.
1 is the oscillating frame for the opening and closing of the machine to obtain espresso like infusions.
2 is the oscillating cradle.
3 is a paddle with matching geometry to that of the capsule containing the infusion product.
4 indicates a switch that turns on the machines and sets its temperature.
5 indicates a switch that turns on the feeding of the process fluid.

The clearness of the figures highlights the simplicity and completeness of espresso machines that is the object of the present industrial invention.

Each technological component can of course be realized with structural dimensioning and proportioning that suit the different technical and commercial demands of the specialized area.

Therefore, all the machines to obtain espresso like infusions that will present the innovative features such as the ones of the present invention, as basically described, illustrated and hereinafter claimed will be considered as being part if the protection sphere of the present invention.

1) Improvements to machines for the production of espresso-like infusions characterized by the fact that they are based on a combination of devices (B,P,R,S,T) that detect, control, regulate and modulate the instant value variations of the technological, thermometric, hydrodynamic and cinematic and chronology parameters that optimize the preset quality of the resulting customized espresso.

2) Improvements to machines for the production of espresso-like infusions, as in claim 1, characterized by the fact that the device (R) regulating the flow of the process fluid presets the quantity, therefore the infusions and delivery time, thus defining the density of the resulting customized creamy espresso.

3) Improvements to machines for the production of espresso-like infusions, as in claim 1, characterized by the fact that they include a discharge hydraulic circuit (S) which, at the end of each infusion cycle, discharges the pressure of the process fluid, eliminating the part of liquid made turbid by the infusions, and keeps the delivery circuit clean freeing it from residual odours and tastes before starting a new infusion cycle.

4) Improvements to machines for the production of espresso-like infusions, as in claim 1, characterized by the fact that the device (T) indicator/regulator of the temperature regulates, controls and modulates the pattern of the infusions process temperature according to the customized quality of the desired espresso.
